(19) United States
(12) Patent Application Publication
(10) Pub. No.: US 2026/0302904 A1
(43) Pub. Date: Oct. 1, 2026

(54) NON-MAGNETIZATION MODIFICATION SOURCE-CONTAINING PASTE, APPLICATION DEVICE FOR THE SAME, ROTOR CORE USING THE SAME, AND METHOD FOR MANUFACTURING THE SAME

(71) Applicant: HONDA MOTOR CO., LTD., Tokyo (JP)

(72) Inventors: Kazuki MATSUURA, Wako-shi (JP); Naoyoshi UMEDA, Wako-shi (JP); Yoshiyuki NAKAZAWA, Wako-shi (JP); Hitoshi ITAMI, Wako-shi (JP); Kai TSUNEKAWA, Wako-shi (JP)

(21) Appl. No.: 19/573,287

(22) Filed: Mar. 20, 2026

(30) Foreign Application Priority Data
Mar. 31, 2025 (JP) 2025-059355

(51) Int. Cl. H02K 15/121; H02K 1/276; H02K 15/035

(52) U.S. Cl. CPC H02K 15/121; H02K 1/276; H02K 15/035; H02K 2215/00

(57) ABSTRACT

A rotor core in which electrical steel sheets each including a Fe—Si alloy are layered with an insulation coating being interposed between the electrical steel sheets. The electrical steel sheets each include a bridge portion including a Fe—Si—Mn alloy, the bridge portion having been subjected to non-magnetization modification with a non-magnetization modification source-containing paste including a manganese powder which is a non-magnetization modification source, an organic binder, a thixotropy-imparting agent, and an organic solvent.

### CROSS REFERENCE TO RELATED APPLICATIONS

This application claims the foreign priority benefit under 35 U.S.C. § 119 of Japanese patent application No. 2025-059355, filed on Mar. 31, 2025, the disclosure of which is incorporated herein by reference.

### BACKGROUND OF THE INVENTION

### 1. Field of the Invention

The present invention relates to a non-magnetization modification source-containing paste, an application device for the same, a rotor core using the same, and a method for manufacturing the same.

### 2. Description of the Related Art

In recent years, efforts to achieve a low-carbon society or a decarbonized society have been active, and for vehicles as well, research and development on electric vehicles which travel by using rotational powers of rotating electrical machines have been conducted in order to reduce CO₂ emissions and improve energy efficiencies.

Conventionally, as a rotor core of a rotating electrical machine, a rotor core in which bridge portions (also referred to as reinforcement ribs), which are formed around housing holes of permanent magnets, are subjected to non-magnetization processing has been known (see, for example, Patent Literature 1). Specifically, in this rotor core, by alloying a metal powder for modification which is applied to bridge portions and a metal contained in an electrical steel sheet forming the rotor core, the permeability of the bridge portions are made lower than the permeability in general portions of the electrical steel sheet. In this way, in the rotating electrical machine, a decrease in apparent permeance between a rotor and a stator can be suppressed, and a decrease in efficiency can thus be prevented.

### Patent Literature

Patent Literature 1: WO2022/004672

### SUMMARY OF THE INVENTION

However, a rotor core is formed by stacking electrical steel sheets, and there are several tens of bridge portions in a single electrical steel sheet. For this reason, in the conventional rotor cores, the non-magnetization of bridge portions is cumbersome, and it takes time to manufacture a rotor core. In addition, in the conventional non-magnetization in which only a metal powder is attached to bridge portions, the permeability of bridge portions cannot be sufficiently and stably reduced.

In view of this, an object of the present invention is to provide a non-magnetization modification source-containing paste which enables non-magnetization modification of bridge portion to be performed more simply and quickly than the conventional technique, and which can sufficiently and stably reduce the permeability of the bridge portions, an application device for the same, a rotor core using the same, and a method for manufacturing the same. Then, the present invention in turn contributes to an improvement in energy efficiency.

A first aspect of the present invention which achieved the above-described object is a non-magnetization modification source-containing paste containing a non-magnetization modification source which is required to be melted in a post-process at a portion requiring non-magnetization modification in an electrical steel sheet, the non-magnetization modification source-containing paste including a manganese powder which is the non-magnetization modification source, an organic binder, a thixotropy-imparting agent, and an organic solvent.

A second aspect of the present invention which achieved the above-described object is an application device for application of the non-magnetization modification source-containing paste, including a rotating body including a cylindrical rotary printing plate having a through-hole that applies the non-magnetization modification source-containing paste to a position at which a portion to be non-magnetized is included in the electrical steel sheet, a rotary drive for the rotating body, a paste supplier that supplies the non-magnetization modification source-containing paste to an inside of the rotating body, a squeegee that holds back the non-magnetization modification source-containing paste being moved in a rotational direction of the rotating body inside the rotating body, and a synchronizer that synchronizes a rotational speed of the rotating body and a feed speed of the electrical steel sheet.

In addition, a third aspect of the present invention which achieved the above-described object is a rotor core in which electrical steel sheets each including a Fe—Si alloy are layered with an insulation coating being interposed between the electrical steel sheets. The electrical steel sheets each include a bridge portion including a Fe—Si—Mn alloy, the bridge portion having been subjected to non-magnetization modification with the non-magnetization modification source-containing paste.

In addition, a fourth aspect of the present invention which achieved the above-described object is a method for manufacturing a rotor core using the non-magnetization modification source-containing paste, including an application step of applying the non-magnetization modification source-containing paste with a predetermined thickness to a position at which a portion to be non-magnetized is included in the electrical steel sheet, and a non-magnetization modification step of forming a Fe—Si—Mn alloy at the portion to be non-magnetized by melting the electrical steel sheet and the non-magnetization modification source. The thickness of the non-magnetization modification source-containing paste applied in the application step is set to a thickness such that the non-magnetization modification source-containing paste contains manganese in an amount of 25% by weight or more based on a total weight of a region corresponding to the portion to be non-magnetized after completion of the non-magnetization modification step.

The present invention makes it possible to provide a non-magnetization modification source-containing paste which enables non-magnetization modification of a bridge portion to be performed more simply and quickly than the conventional technique, and which can sufficiently and stably reduce the permeability of the bridge portions, an application device for the same, a rotor core using the same, and a method for manufacturing the same.

### BRIEF DESCRIPTION OF THE DRAWINGS

FIG. 1 is a configuration explanatory view of a rotating electrical machine including a rotor core according to an embodiment of the present invention.

FIG. 2 is a partial perspective view of an electrical steel sheet included in the rotor core according to the embodiment of the present invention.

FIG. 3 is a configuration explanatory view of an application device for application of a non-magnetization modification source-containing paste.

FIG. 4 is a developed view of a rotating body included in the application device shown in FIG. 3.

FIG. 5 is a schematic view of an application pattern for the non-magnetization modification source-containing paste.

FIG. 6A is an operation explanatory view of the rotating body included in the application device shown in FIG. 3.

FIG. 6B is an operation explanatory view of a rotating body of a comparative example.

FIG. 7 is a manufacturing step diagram of the rotor core according to the embodiment of the present invention.

FIG. 8 is an explanatory view of an application step for the non-magnetization modification source-containing paste.

FIG. 9 is a graph showing a relation between a concentration of manganese in the applied non-magnetization modification source-containing paste and a percentage of a ferromagnetic layer.

FIG. 10 is a graph showing a relation between a thickness of the non-magnetization modification source-containing paste and a weight percentage of manganese.

### DETAILED DESCRIPTION OF THE EMBODIMENTS

Next, a mode for carrying out the present invention (an embodiment) will be described in detail with reference to the drawings as appropriate.

A non-magnetization modification source-containing paste according to the present embodiment is used for manufacturing a rotor core which is included in a rotating electrical machine, and reduces permeability in bridge portions of an electrical steel sheet which forms the rotor core.

Hereinafter, first, the rotor core of the rotating electrical machine will be described, and then the non-magnetization modification source-containing paste, an application device for application of the non-magnetization modification source-containing paste, and a method for manufacturing a rotor core will be described.

### Rotor Core

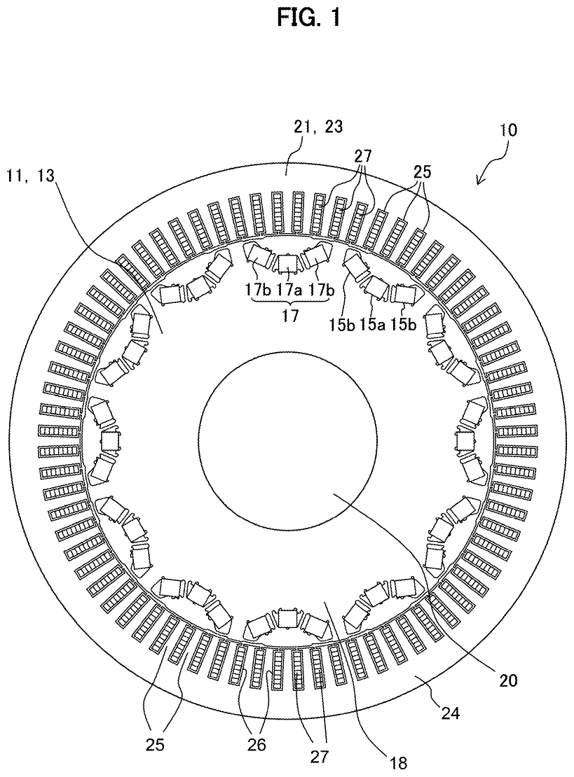

FIG. 1 is a configuration explanatory view of a rotating electrical machine 10 including a rotor core 13 according to the present embodiment, and is a sectional view of the rotating electrical machine 10 which is perpendicular to an axis of the rotating electrical machine 10.

The rotating electrical machine 10 is assumed to be a rotating electrical machine which is mounted on a hybrid vehicle or an electric vehicle and used as an electric motor for driving the vehicle, but can also be used for various other uses.

As shown in FIG. 1, the rotating electrical machine 10 is configured to include a cylindrical rotor 11 and an annular stator 21.

The rotor 11 is disposed on an inner periphery side of the stator 21 to be coaxial with the stator 21. This allows an outer peripheral surface of the rotor 11 to have a slight gap to an inner peripheral surface of the stator 21. The rotor 11 is capable of rotating on the inner periphery side of the stator 21 about a rotor shaft 20 which is integrated with the rotor 11.

On the rotor core 13 included in the rotor 11, permanent magnets 17 formed of a neodymium magnet or the like are disposed. The permanent magnets 17 are disposed along a circumferential direction on an outer periphery side of the rotor core 13. Each permanent magnet 17 is a rod-shaped body having a rectangular section, and extends in an axial direction of the rotor core 13 (a direction perpendicular to the sheet surface of FIG. 1).

Specifically, three permanent magnets 17 are combined as one set, and are arranged side by side at equal intervals in the circumferential direction.

In the sectional view shown in FIG. 1, the three permanent magnets 17 included in this set form a substantially V-shape which is open to an outer side in a radial direction with a permanent magnet 17a which is located at a center in the circumferential direction, and a pair of permanent magnets 17b, 17b which are disposed to sandwich the permanent magnet 17a at the center in the circumferential direction. That is, among the three permanent magnets 17, the pair of permanent magnets 17b, 17b are disposed to be close to the outer peripheral surface of the rotor core 13, and the permanent magnet 17a at the center is displaced to an inner side in the radial direction relative to the pair of permanent magnets 17b, 17b.

The three permanent magnets 17 included in the set are inserted through magnet housing holes 15a, 15b, 15b which are formed in the rotor core 13 to correspond to positions of the respective permanent magnets 17a, 17b, 17b, and are thus attached to the rotor core 13.

The rotor core 13 as described above is configured by stacking, in the axial direction of the rotating electrical machine 10, electrical steel sheets 18 each having a planar shape corresponding to a planar shape of the rotor core 13.

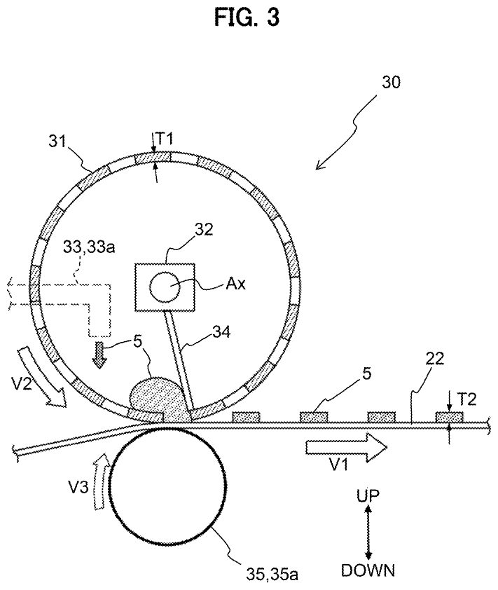

Each electrical steel sheet 18 is blanked from an electrical steel sheet 22 (see FIG. 3), which will be described later, to correspond to the planar shape of the rotor core 13.

The electrical steel sheet 18 in the present embodiment preferably includes a Fe—Si alloy.

The thickness of the electrical steel sheet 18 is preferably 0.1 mm or more and 0.5 mm or less.

Note that in FIG. 1, Reference sign 23 indicates a stator core of the stator 21, Reference sign 24 indicates a yoke of the stator 21, and Reference sign 27 indicates a coil which is disposed in a slot 26 to be wound around teeth 25 of the stator 21.

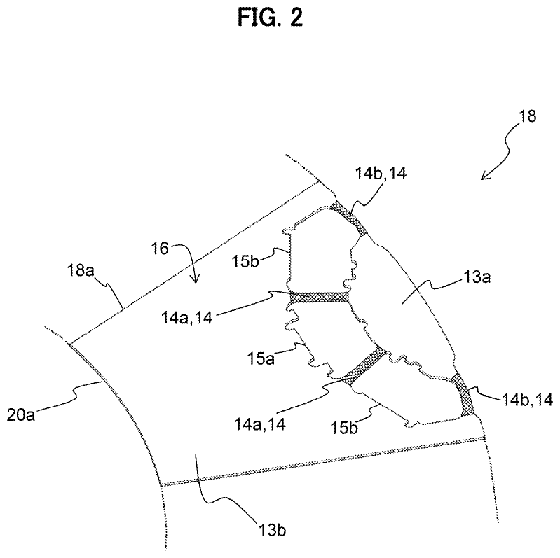

FIG. 2 is a partial perspective view of the electrical steel sheet 18 included in the rotor core 13 (see FIG. 1). For the convenience of illustration, FIG. 2 shows a portion where three permanent magnets 17 (see FIG. 1) included in a set are attached in an enlarged manner. In FIG. 2, Reference sign 20a indicates an attachment hole which is formed in the inner periphery side of the electrical steel sheet 18, to which the rotor shaft 20 (see FIG. 1) is attached.

As shown in FIG. 2, on the outer periphery side of the electrical steel sheet 18, three magnet housing holes 15a, 15b, 15b which correspond to the three permanent magnets 17a, 17b, 17b (see FIG. 1) which form the set are formed.

That is, as shown in FIG. 2, the magnet housing holes 15a, 15b, 15b form a substantially V-shape which is open to the outer side in the radial direction with a magnet housing hole 15a which is located at a center in the circumferential direction, and a pair of magnet housing holes 15b, 15b which are disposed to sandwich the magnet housing hole 15a at the center in the circumferential direction.

In addition, the electrical steel sheet 18 includes bridge portions 14 which connect an outer core portion 13a and an inner core portion 13b. In FIG. 2, the bridge portions 14 are shaded for the convenience of illustration.

As shown in FIG. 2, the bridge portions 14 include inner bridge portions 14a which are formed between the magnet housing hole 15a and the magnet housing holes 15b, and outer bridge portions 14b which are formed between end edges of the outermost periphery sides in the magnet housing hole 15b and the outer peripheral edge of the electrical steel sheet 18.

These bridge portions 14 have a reduced permeability as compared with that of a general portion 18a of the electrical steel sheet 18. The permeability of the bridge portions 14 is reduced by the alloying with a metal component (modification source) contained in the non-magnetization modification source-containing paste which will be described next.

Note that in FIG. 2, Reference sign 16 indicates an insulation coating which is formed at nanometer level to micrometer level on both surfaces of the electrical steel sheet 18.

This insulation coating 16 is formed on an electrical steel sheet 22 (see FIG. 3) described later, which serves as a raw sheet of the electrical steel sheet 18 before the non-magnetization modification source-containing paste, which will be described next, is applied.

### Non-Magnetization Modification Source-Containing Paste

The non-magnetization modification source-containing paste of the present embodiment contains a manganese powder, which is a non-magnetization modification source, an organic binder, a thixotropy-imparting agent, and an organic solvent.

As the manganese powder, a manganese powder which is formed of metallic manganese and which is an undersized component obtained using a sieve having a mesh size of 75 μm compliant with JIS Z 8801 can be used, and preferably the manganese powder is one having a median diameter (D50) of around 10 μm as measured by a laser diffraction and scattering method. However, the manganese powder is not limited to these.

The content of the manganese powder in the non-magnetization modification source-containing paste is preferably 85.0 to 95.0% by weight.

The organic binder includes, for example, cellulose-based polymers such as ethyl cellulose and hydroxyethyl cellulose, acrylic resins such as polybutyl methacrylate, polymethyl methacrylate, and polyethyl methacrylate, epoxy resin, phenol resin, alkyd resin, polyvinyl alcohol, polyvinyl butyral, and the like, but is not limited to these. Among these, an acrylic resin is preferable.

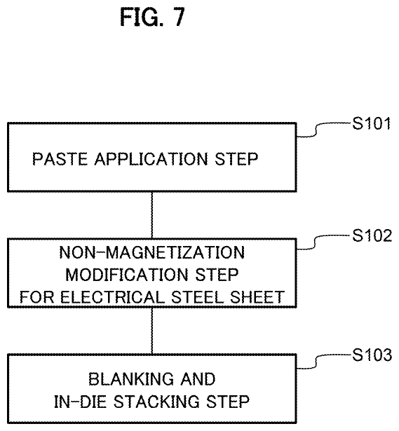

The organic binder functions as a binder component which binds and adjusts the manganese powder into the form of paste in the non-magnetization modification source-containing paste, and is considered to function as a carbon source of carbon atoms to be dispersed into the electrical steel sheet in a non-magnetization modification step (see FIG. 7), which will be described later.

The content of the organic binder in the non-magnetization modification source-containing paste is preferably 0.3 to 1.0% by weight.

The thixotropy-imparting agent includes, for example, organic thixotropy-imparting agents such as hydrogenated castor oil and stearic acid amide, but is not limited to these. The thixotropy-imparting agent in the present embodiment imparts shape retention properties to the non-magnetization modification source-containing paste applied in an application step for a non-magnetization modification source-containing paste (see FIG. 7) to an electrical steel sheet, which will be described later. In addition, the thixotropy-imparting agent also functions as a carbon source of carbon atoms to be dispersed into the electrical steel sheet in the non-magnetization modification step (see FIG. 7), which will be described later.

The content of the thixotropy-imparting agent in the non-magnetization modification source-containing paste is preferably 0.5 to 1.5% by weight.

The organic solvent includes, for example, ester-based solvents such as butyl cellosolve acetate and butyl carbitol acetate (BCA: diethylene glycol monobutyl ether acetate), ether-based solvents such as butyl carbitol (BC: diethylene glycol monobutyl ether), ethylene glycol, diethylene glycol delivatives, toluene, xylene, mineral spirits, terpineol, menthanol, and the like, but is not limited to these. Among these, butyl carbitol is preferable.

The organic solvent imparts fluidity to the non-magnetization modification source-containing paste, and is considered to function as a carbon source of carbon atoms to be dispersed into the electrical steel sheet in the non-magnetization modification step (see FIG. 7), which will be described later.

The content of the organic solvent in the non-magnetization modification source-containing paste is preferably 2.5 to 15.0% by weight.

The non-magnetization modification source-containing paste can be prepared by mixing the above-described constituent components.

### Application Device for Application of Non-Magnetization Modification Source-Containing Paste

FIG. 3 is a configuration explanatory view of an application device 30 for application of the non-magnetization modification source-containing paste.

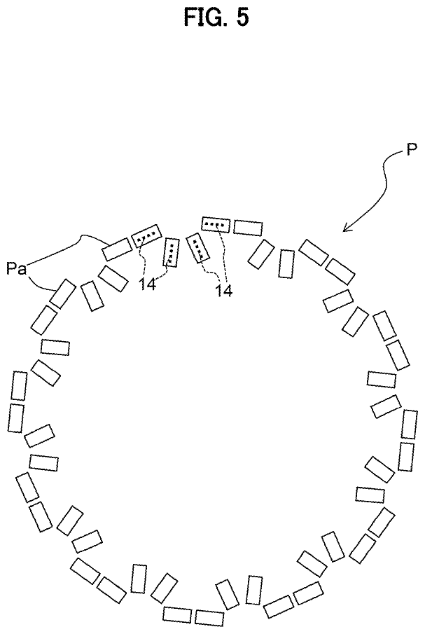

As shown in FIG. 3, the application device 30 of the present embodiment is configured to apply a non-magnetization modification source-containing paste 5 (hereinafter, sometimes referred to simply as a “paste 5”) to a surface of an electrical steel sheet 22, which is conveyed at a predetermined feed speed V1, with a predetermined application pattern P (see FIG. 5), which will be described later.

The electrical steel sheet 22 in the present embodiment is a raw sheet of the electrical steel sheet 18 (see FIG. 2), and preferably includes the above-described Fe—Si alloy.

As shown in FIG. 3, the application device 30 of the present embodiment includes a rotating body 31 and a rotary drive 32 for the rotating body 31. In addition, the application device 30 includes a paste supplier 33 that supplies the paste 5 to the inside of the rotating body 31, and a squeegee 34 which is disposed inside the rotating body 31. In addition, the application device 30 includes a synchronizer 35 that synchronizes the rotational speed of the rotating body 31 and the feed speed of the electrical steel sheet 22.

As shown in FIG. 3, the rotating body 31 includes a cylindrical rotary printing plate.

The rotating body 31 is disposed upward of the electrical steel sheet 22, and an outer peripheral surface of the rotating body 31 is in contact with an upper surface of the electrical steel sheet 22.

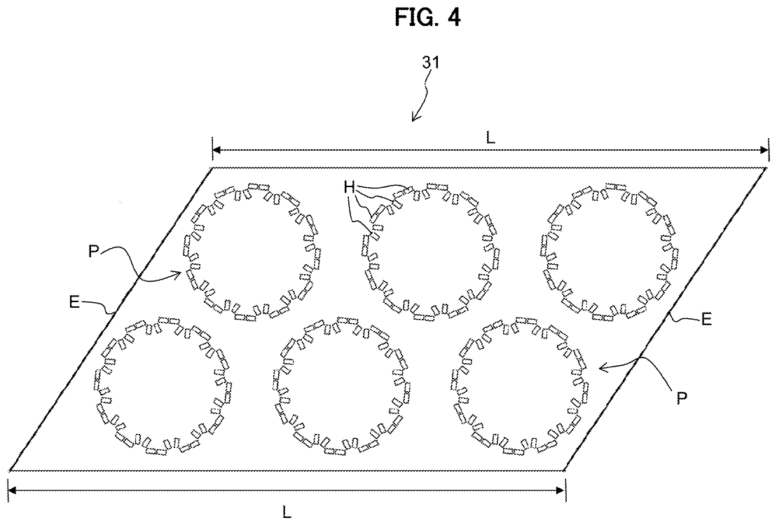

FIG. 4 is a developed view of the rotating body 31.

As shown in FIG. 4, the planar shape of the developed rotating body 31 is a parallelogram having opposite sides of a length L which is equal to the circumferential length of the rotating body 31. The rotating body 31 is formed by roll-forming a plate body which has such a planar shape of a parallelogram and has a predetermined thickness T1 (see FIG. 3), and joining seams of end edges E shown in FIG. 4 with each other.

Note that the thickness T1 of the rotating body 31 shown in FIG. 3 can be set to be substantially equal to an application thickness T2 of the paste 5 to the electrical steel sheet 22. Incidentally, the rotating body 31 in the present embodiment is assumed to be a rotating body having a thickness T1 of 0.25 mm or more.

As shown in FIG. 4, the rotating body 31 has through-holes H which penetrate the plate body in a thickness direction (a direction perpendicular to the sheet surface of FIG. 4).

The through-holes H are arranged side by side on a circumference of a predetermined diameter, and form an application pattern P of the paste 5 (see FIG. 3) to the electrical steel sheet 22 (see FIG. 3).

FIG. 5 is a schematic view of the application pattern P of the paste 5 (see FIG. 3).

As shown in FIG. 5, the application pattern P is formed of an assembly of minute rectangular sectional regions Pa in plan view.

This sectional region Pa (see FIG. 5) is formed to correspond to the bridge portion 14 (see FIG. 2) of the electrical steel sheet 18 (see FIG. 2).

Specifically, as shown in FIG. 5, the sectional region Pa is formed to have an area of a size which encompasses the bridge portion 14 indicated by an imaginary line (a dotted line).

That is, as described above, the sectional regions Pa are formed at positions which contain the bridge portions 14 (see FIG. 2) which are “portions to be non-magnetized” of the electrical steel sheet 22 (see FIG. 3) from which the electrical steel sheet 18 (see FIG. 2) is to be blanked.

Referring back to FIG. 4, as described above, the rotating body 31 has the application patterns P formed by the through-holes H.

The application patterns P of the rotating body 31 in the present embodiment are such that two rows of the application patterns P are arranged side by side in a direction in which the opposite sides having the length L face each other (the axial direction of the rotating body 31), and continue to form a staggered pattern at 60 degrees in a direction parallel to the opposite sides (the circumferential direction of the rotating body 31), in the state where the rotating body 31 is developed as shown in FIG. 4.

In addition, as shown in FIG. 4, the rotating body 31 in such present embodiment is such that the end edge Es, which are the seams of the rotating body 31, are set at positions where there are no application patterns P.

As shown in FIG. 3, the rotary drive 32 is provided at one end in an extension direction of a rotational axis Ax of the rotating body 31 (a direction perpendicular to the sheet surface of FIG. 3). The rotary drive 32 in the present embodiment is assumed to be configured with an electric motor and a reduction gear which rotate the rotating body 31 at a predetermined speed.

As shown in FIG. 3, the paste supplier 33 is configured to continuously or intermittently supply the paste 5 to the inside of the rotating body 31.

The paste supplier 33 in the present embodiment is assumed to have a reservoir portion (not shown) for the paste 5, a pipe 33a extending from this reservoir portion to the inside of the rotating body 31, and a pump (not shown) provided in a middle of the extending pipe 33a.

As shown in FIG. 3, the squeegee 34 is configured with a plate body which holds back the paste 5 being moved in a rotational direction of the rotating body 31 on the lower side of the inside of the rotating body 31.

The squeegee 34 in the present embodiment is such that one end edge of the squeegee 34, which extends in the axial direction of the rotating body 31 (the direction perpendicular to the sheet surface of FIG. 3) on the center side of the rotating body 31, is supported by a supporting portion, which is not shown. In addition, the other end edge, which is located below the one end edge, of the squeegee 34 is in sliding contact with the inner peripheral surface of the rotating body 31 which rotates.

In addition, the squeegee 34 in the present embodiment is assumed to be formed of a flexible member such as a hard rubber plate, a resin plate, or a metal plate, for example. The squeegee 34 is such that the other end edge of the squeegee 34, which is in sliding contact with the inner peripheral surface of the rotating body 31, is slightly displaced in the rotational direction of the rotating body 31.

The synchronizer 35 is configured to synchronize the rotational speed of the rotating body 31 (a speed V2 of the outer peripheral surface of the rotating body 31 in the circumferential direction) and the feed speed V1 of the electrical steel sheet 22.

The synchronizer 35 in the present embodiment includes a roller 35a.

The roller 35a is disposed below the rotating body 31, and is in pressure contact with a lower surface of the electrical steel sheet 22 which is in contact with the outer peripheral surface of the rotating body 31.

In addition, although not shown, the synchronizer 35 includes a gear mechanism which transmits a rotational operation of the rotating body 31 to the roller 35a. This gear mechanism transmits, to the roller 35a, a rotational force in a direction opposite to that of the rotating body 31, and sets a speed V3 of an outer peripheral surface of the roller 35a such that the speed V3 becomes equal to the speed V2 of the outer peripheral surface of the rotating body 31.

This allows the electrical steel sheet 22 to be conveyed at the feed speed V1 which is equal to the speed V2 of the outer peripheral surface of the rotating body 31. Note that the feed speed V1 in the present embodiment is assumed to be around 20 m/min. However, the feed speed V1 can be adjusted as appropriate.

Next, an operation of the rotating body 31 will be described.

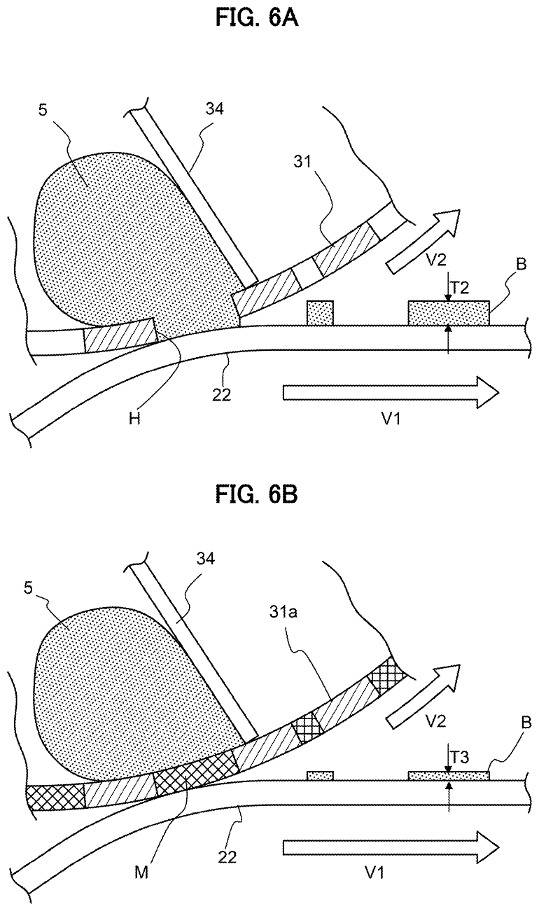

FIG. 6A is an operation explanatory view of the rotating body 31.

As shown in FIG. 6A, when the rotating body 31 rotates in a feeding direction of the electrical steel sheet 22, the paste 5 is about to move in a following manner in the rotational direction of the rotating body 31 on the lower side of the inside of the rotating body 31.

The squeegee 34 holds back the paste 5 being moved in the following manner in the rotational direction of the rotating body 31.

When the through-hole H of the rotating body 31 has reached the upstream side of the squeegee 34 in the rotational direction of the rotating body 31, the paste 5 pushed by the squeegee 34 is put into the through-hole H.

When the rotating body 31 further rotates to cause the squeegee 34 to push out the paste 5 put in the through-hole H toward the electrical steel sheet 22, a block B having a minute cuboid shape, which is formed of the paste 5, is attached and formed on the upper surface of the electrical steel sheet 22. This block B has a planar shape corresponding to the rectangular sectional region Pa (see FIG. 5) of the application pattern P (see FIG. 5), and has a thickness T2 substantially equal to the thickness T1 (see FIG. 3) of the plate body which forms the rotating body 31 (see FIG. 3).

The application thickness T2 of the paste 5, which is the thickness of the block B in the present embodiment, is a thickness with which the paste 5 contains manganese at a weight ratio of 25% by weight or more, and preferably 30% by weight or more, with respect to the portion to be non-magnetized (see FIG. 2).

Specifically, the application thickness T2 (see FIG. 6A) of the paste 5 is preferably 0.25 mm or more as described in Example described later.

FIG. 6B is an operation explanatory view of a rotating body 31a of a comparative example.

As shown in FIG. 6B, the rotating body 31a is different from the rotating body 31 (see FIG. 6A) in the present embodiment in that the rotating body 31a does not include the through-holes H (see FIG. 6A), and includes mesh M in portions corresponding to the through-holes H.

In the rotating body 31a of this comparative example, a thickness T3 of a block B attached and formed on the upper surface of the electrical steel sheet 22 becomes equal to half or less than half of the thickness T2 (see FIG. 6A). Note that in FIG. 6B, Reference sign 5 indicates a paste, and Reference sign 34 indicates a squeegee.

### Method for Manufacturing Rotor Core

Next, a method for manufacturing the rotor core 13 (see FIG. 1) will be described.

As shown in FIG. 7, this manufacturing method includes an application step (step S101) for the paste 5 (see FIG. 3) to the electrical steel sheet 22 (see FIG. 3), a non-magnetization modification step (step S102) for the electrical steel sheet 22 (see FIG. 3) to which the paste 5 (see FIG. 3) has been applied, and a blanking and in-die stacking step (step S103) for the electrical steel sheet 22 (see FIG. 3).

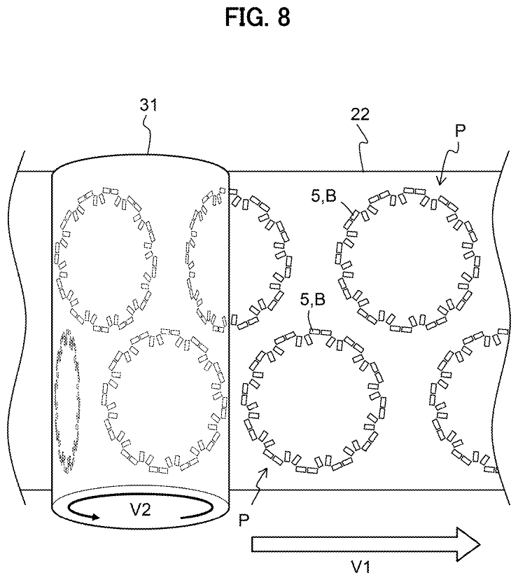

FIG. 8 is an explanatory view of the application step (step S101).

As shown in FIG. 8, in the application step (step S101 of FIG. 7), the electrical steel sheet 22 is conveyed at the feed speed V1 which is equal to the speed V2 of the outer peripheral surface of the rotating body 31 by the synchronizer 35 (see FIG. 3).

At this time, as shown in FIG. 6A, the squeegee 34 holds back the paste 5 being moved by the rotating body 31, and attaches and forms the block B of the paste 5 which has the thickness T2 in the planar shape of the through-hole H on the upper surface of the electrical steel sheet 22.

As shown in FIG. 8, on the upper surface of the electrical steel sheet 22 being conveyed at the feed speed V1, application patterns P are continuously formed with the paste 5.

In the non-magnetization modification step (step S102) shown in FIG. 7, each of the blocks B (see FIG. 8) which form the application patterns P is sequentially irradiated with an energy beam such as a laser beam or an electron beam. This allows the electrical steel sheet 22 (see FIG. 8) and the block B (see FIG. 8) to be heated at a high temperature. The manganese powder contained in the block B is melted, and the components of the paste 5 other than the manganese powder are burned, so that part of the components is carbonized. This allows a metal component forming the electrical steel sheet 22 and the manganese to form a Fe—Si—Mn alloy, so that the permeability of the portions irradiated with the energy beam decreases. In the electrical steel sheet 22, all the sectional regions Pa (see FIG. 5) containing the bridge portions 14 are subjected to non-magnetization modification. Note that at this time, part of carbon atoms generated in the burnt blocks B may be dispersed into the electrical steel sheet 22, whereby part of the modified region forms a Fe—Si—Mn—C alloy.

Next, in this manufacturing method, the electrical steel sheet 22 is blanked in a shape corresponding to the planar shape of the rotor core 13 (see FIG. 1). At this time, as shown in FIG. 2, the bridge portions 14 and the magnet housing holes 15a, 15b, 15b are formed in the electrical steel sheet 22. That is, portions other than the bridge portions 14 (see FIG. 5) in the sectional regions Pa (see FIG. 5) which have been subjected to the non-magnetization modification are trimmed.

Then, the electrical steel sheets 18 blanked from the electrical steel sheet 22 (see FIG. 8) are stacked and staked in a predetermined die, and the stacked electrical steel sheets 18 are integrated with an adhesive or the like as necessary, and the blanking and in-die stacking step (step S103) ends. In this way, the rotor core 13 (see FIG. 1) of the present embodiment is completed.

### <<Operations and Effects>>

Next, the operations and effects exerted by the non-magnetization modification source-containing paste, the application device for the same, the rotor core using the same, and the method for manufacturing the same according to the present embodiment will be described.

The paste 5 (the non-magnetization modification source-containing paste) according to the present embodiment is a non-magnetization modification source-containing paste containing a non-magnetization modification source which is configured to be melted at a portion requiring non-magnetization modification in an electrical steel sheet 22 in a post-process, the non-magnetization modification source-containing paste including a manganese powder which is the non-magnetization modification source, an organic binder, a thixotropy-imparting agent, and an organic solvent.

According to such paste 5 (the non-magnetization modification source-containing paste), the state where the non-magnetization modification source is in contact with the electrical steel sheet 22 can be maintained for a long period of time, unlike the conventional technique in which only a metal powder is attached to a bridge portion (see, for example, Patent Literature 1). In addition, according to such paste 5 (the non-magnetization modification source-containing paste), the amount of the non-magnetization modification source can be maintained with high accuracy on a portion which needs non-magnetization modification in the electrical steel sheet 22.

In this way, the paste 5 (the non-magnetization modification source-containing paste) of the present embodiment makes it possible to perform non-magnetization modification of the bridge portion 14 more simply and quickly than the conventional technique, and sufficiently and stably reduce the permeability of the bridge portion 14.

In addition, the application device 30 according to the present embodiment is an application device 30 for application of the paste 5 (the non-magnetization modification source-containing paste), including a rotating body 31 including a cylindrical rotary printing plate having a through-hole H that applies the paste 5 to a position at which a portion to be non-magnetized (a bridge portion 14) is included in the electrical steel sheet 22, a rotary drive 32 for the rotating body 31, a paste supplier 33 that supplies the paste 5 to an inside of the rotating body 31, a squeegee 34 that holds back the paste 5 being moved in a rotational direction of the rotating body 31 inside the rotating body 31, and a synchronizer 35 that synchronizes a speed V2 of the rotating body 31 and a feed speed V1 of the electrical steel sheet 22.

According to such application device 30, the non-magnetization modification source can be continuously applied to the electrical steel sheet 22. In addition, according to such application device 30, the paste 5 having a thickness necessary for the non-magnetization of the electrical steel sheet 22 can be precisely applied to an appropriate position. In this way, the application device 30 of the present embodiment can perform non-magnetization modification of the bridge portion 14 more simply and quickly than the conventional technique, and sufficiently and stably reduce the permeability of the bridge portion 14.

In addition, the rotor core 13 according to the present embodiment is a rotor core 13 in which electrical steel sheets 18 each including a Fe—Si alloy are layered with an insulation coating 16 being interposed between the electrical steel sheets 18. The electrical steel sheets 18 include bridge portions 14 each including a Fe—Si—Mn based alloy, the bridge portion having been subjected to non-magnetization modification with the paste 5.

Since the bridge portion 14 of such rotor core 13 has been subjected to the non-magnetization modification with the paste 5 (the non-magnetization modification source-containing paste), the permeability of the bridge portion 14 can be sufficiently and stably reduced.

In addition, the method for manufacturing the rotor core 13 according to the present embodiment is a method for manufacturing a rotor core 13 using the paste 5, including an application step of applying the paste 5 with a predetermined thickness T2 to a position at which a bridge portion 14 (a portion to be non-magnetized) is included in an electrical steel sheet 22, and a non-magnetization modification step of forming a Fe—Si—Mn alloy at the bridge portion 14 by melting the electrical steel sheet 22 and the non-magnetization modification source. The thickness T2 of the paste 5 applied in the application step is set to a thickness such that the paste 5 contains manganese in an amount of 25% by weight or more based on a total weight of the bridge portion 14 after the non-magnetization modification.

According to such method for manufacturing a rotor core 13, the non-magnetization modification of the bridge portion 14 can be performed more simply and quickly than the conventional technique. In addition, according to this manufacturing method, an amount of the non-magnetization modification source can be applied more surely and accurately in a portion where the non-magnetization modification is required in the electrical steel sheet 22.

Although the present embodiment has been described above, the present invention is not limited to the above-described embodiment, and can be implemented in various modes.

### EXAMPLE

Next, Example of the method for manufacturing a rotor core 13 in the present invention will be described.

In the present Example, a preferable range for the application thickness T2 (see FIG. 3) of the paste 5 to the portion to be non-magnetized in the electrical steel sheet 18 to be included in the rotor core 13 was examined.

In the present Example, as the paste 5, a paste containing 90% by weight of a manganese powder, 5% by weight of an acrylic resin as an organic binder, 1% by weight of an organic thixotropy-imparting agent, and 4% by weight of an organic solvent was prepared.

Next, test pieces obtained by applying the paste 5 to the surface of an electrical steel sheet which includes a Fe—Si alloy and has a thickness of 0.3 mm were fabricated. As the test pieces, 40 types of test pieces in which the application thickness T2 of the paste 5 was changed within a range from 0.16 mm to 0.36 mm were prepared.

Next, portions of the paste 5 applied to these 40 types of test pieces were irradiated with a laser beam, so that the test pieces formed of the electrical steel sheets were partially non-magnetized.

For each portion subjected to the non-magnetization modification, a percentage of a ferromagnetic phase (% by volume) and a concentration of carbon (% by weight) were measured. Then, a relation between the concentration of manganese (% by weight) to the portions to which the paste 5 was applied and the percentage of the ferromagnetic phase (% by volume) was obtained.

As the proportion of the ferromagnetic phase, the volume ratio of an α-Fe phase was measured by an X-ray diffraction method. As the concentration of carbon [C] (% by weight), carbon contained in a combustion gas in an oxygen stream of the portion subjected to the non-magnetization modification was measured by an infrared absorption method. The concentration of manganese [Mn] (% by weight) was measured by an ICP emission spectral analysis method.

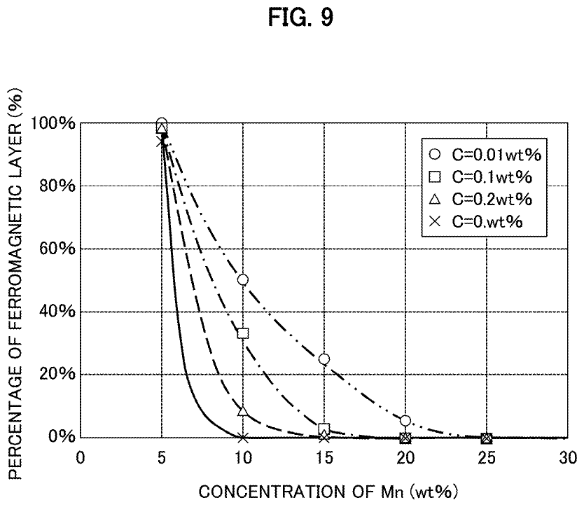

Results are shown in FIG. 9.

FIG. 9 is a graph showing a relation between the concentration of manganese (% by weight) in the applied paste 5 and the percentage of the ferromagnetic layer (% by volume).

As shown in FIG. 9, it was confirmed that in all the cases where the concentration of carbon was 0% by weight, 0.01% by weight, 0.1% by weight, and 0.2% by weight, and the test piece (electrical steel sheet) was non-magnetized when the concentration of manganese was 25% by weight.

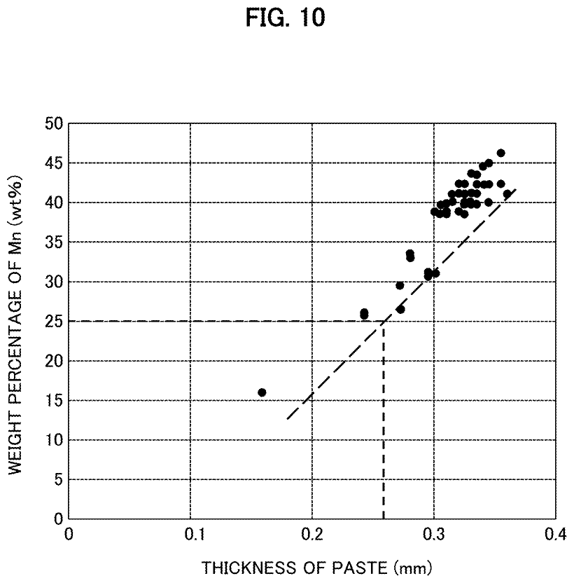

FIG. 10 is a graph showing a relation between the thickness of the applied paste 5 (mm) and the concentration of manganese (% by weight) in the applied paste 5.

As shown in FIG. 10, it was revealed that at least in the case where the concentration of carbon was 0.01% by weight, the concentration of manganese in the applied paste 5 was made to be 25% by weight or more by setting the thickness of the paste 5 to 0.25 mm or more.

It was verified that the application thickness T2 of the paste 5 with which an electrical steel sheet was non-magnetized was preferably 0.25 mm or more.

It is understood that the foregoing description is that of the preferred embodiments of the invention and that various changes and modifications may be made thereto without departing from the spirit and scope of the invention as defined in the appended claims.

What is claimed is:

1. A non-magnetization modification source-containing paste containing a non-magnetization modification source which is required to be melted in a post-process at a portion requiring non-magnetization modification in an electrical steel sheet, the non-magnetization modification source-containing paste comprising:
a manganese powder which is a non-magnetization modification source;
an organic binder;
a thixotropy-imparting agent; and
an organic solvent.

2. An application device for application of the non-magnetization modification source-containing paste according to claim 1, the application device comprising:
a rotating body including a cylindrical rotary printing plate having a through-hole configured to apply the non-magnetization modification source-containing paste to a position at which a portion to be non-magnetized is included in the electrical steel sheet;
a rotary drive for the rotating body;
a paste supplier configured to supply the non-magnetization modification source-containing paste to an inside of the rotating body;
a squeegee configured to hold back the non-magnetization modification source-containing paste being moved in a rotational direction of the rotating body inside the rotating body; and
a synchronizer configured to synchronize a rotational speed of the rotating body and a feed speed of the electrical steel sheet.

3. A rotor core in which electrical steel sheets each including a Fe—Si alloy are layered with an insulation coating being interposed between the electrical steel sheets, wherein
the electrical steel sheets each include a bridge portion including a Fe—Si—Mn alloy, the bridge portion having been subjected to non-magnetization modification with the non-magnetization modification source-containing paste according to claim 1.

4. A method for manufacturing a rotor core by using the non-magnetization modification source-containing paste according to claim 1, the method comprising:
applying the non-magnetization modification source-containing paste with a predetermined thickness to a position at which a portion to be non-magnetized is included in the electrical steel sheet; and
forming a Fe—Si—Mn alloy at a portion to be non-magnetized by melting the electrical steel sheet and the non-magnetization modification source, wherein
a thickness of a non-magnetization modification source-containing paste applied during the applying is set to a thickness such that the non-magnetization modification source-containing paste contains manganese at a weight ratio of 25% by weight or more with respect to the portion to be non-magnetized.
